(19) United States
(12) Patent Application Publication
(10) Pub. No.: US 2016/0103261 A1
(43) Pub. Date: Apr. 14, 2016

(54) OPTICAL FIBER ILLUMINATION SYSTEMS PRODUCING COLOR MOVEMENT

(71) Applicant: Corning Incorporated, Corning, NY (US)

(72) Inventors: Anthony Sebastian Bauco, Horseheads, NY (US); Paul Michael Then, Victor, NY (US)

(73) Assignee: Corning Incorporated, Corning, NY (US)

(21) Appl. No.: 14/879,348

(22) Filed: Oct. 9, 2015

Related U.S. Application Data
(60) Provisional application No. 62/062,381, filed on Oct. 10, 2014.

(51) Int. Cl. F21V 8/00; G02B 6/028; H05B 33/08; G02B 6/02

(52) U.S. Cl. CPC G02B 6/001; G02B 6/0006; G02B 6/0229; G02B 6/0288; G02B 6/0003; H05B 33/0812; H05B 33/086

(57) ABSTRACT

An illumination system configured to produce color movement along the length of an optical fiber. The system can include a light-diffusing optical fiber having a first input end and a second input end, a glass core, a cladding surrounding the glass core, and an outer surface. Nano-sized structures are situated within the glass core or at the core-cladding boundary in order to scatter light. A first light source is optically coupled to the first input end, and a second light source is optically coupled to the second input end. A color variation forms within the optical fiber at the junction of the light emitted from each end of the fiber, and adjusting the intensity of light emitted from one or more of the first light source and the second light source causes the location of the color variation to move along the length of the optical fiber.

### CROSS-REFERENCE TO RELATED APPLICATIONS

This application claims the benefit of priority under 35 U.S.C. §119 of U.S. Provisional Application Ser. No. 62/062,381 filed on Oct. 10, 2014, the content of which is relied upon and incorporated herein by reference in its entirety.

### FIELD OF THE INVENTION

The present specification generally relates to light-diffusing optical fibers for use in illumination applications and, more specifically, to light-diffusing optical fibers capable of producing color movement along the length of the fiber.

Optical fibers are used for a variety of applications where light needs to be delivered from a light source to a remote location. Optical telecommunication systems, for example, rely on a network of optical fibers to transmit light from a service provider to system end-users.

Telecommunication optical fibers are designed to operate at near-infrared wavelengths in the range from 800 nm to 1675 nm where there are only relatively low levels of attenuation due to absorption and scattering. This allows most of the light injected into one end of the fiber to exit the opposite end of the fiber with only insubstantial amounts exiting peripherally through the sides of the fiber.

Recently, however, there has been a growing need to have optical fibers that are less sensitive to bending than conventional fibers. This is because more and more telecommunication systems are being deployed in configurations that require the optical fiber to be tightly bent. This need has led to the development of optical fibers that utilize a ring of small non-periodically disposed voids that surround the core region. The void containing ring serves to increase the bend insensitivity—that is to say, the fiber can have a smaller bend radius without suffering a significant change in the attenuation of the optical signal propagating in the fiber. Optical losses are minimized by placing the void containing ring region in the cladding of the optical fiber (some distance from the core); thus, the amount of light propagating through void containing ring region is minimized.

Because optical fibers are typically designed to efficiently deliver light from one end of the fiber to the other end of the fiber over long distances, very little light escapes from the sides of the typical fiber, and, therefore optical fibers are not considered to be well-suited for use in forming an extended illumination source. Yet, there are a number of applications such as special lighting, signage, or biological applications, including bacteria growth and the production of photo-bioenergy and biomass fuels, where select amounts of light need to be provided in an efficient manner to the specified areas. For biomass growth there is a need to develop processes that convert light energy into biomass-based fuels. For special lighting the light source needs to be thin, flexible, and easily modified to variety of different shapes.

Bend insensitive light-diffusing optical fibers have many applications in automotive, appliance, architecture, retail, and other markets using light as a decorative and/or indicating feature. However, the colored light emitted from existing light-diffusing optical fibers is largely static, with the only change in emitted light being a full change of one light color for another light color along the full length of the optical fiber.

Accordingly, there is a need in the art for light-diffusing optical fiber systems capable of producing color movement along the length of the fiber.

### SUMMARY OF THE INVENTION

The present specification is directed to illumination systems with light-diffusing optical fibers capable of producing color movement along the length of the fiber.

According to one embodiment an illumination system including:
a light-diffusing optical fiber comprising a first input end and a second input end, the light-diffusing optical fiber having a glass core, a cladding surrounding the glass core, and an outer surface, and further comprising a plurality of nano-sized structures situated within the fiber, the nano-sized structures being configured to scatter light;
a first light source optically coupled to the first input end of the light-diffusing optical fiber and configured to generate light having a first wavelength, wherein an intensity of light emitted from the first light source is adjustable; and
a second light source optically coupled to the second input end of the light-diffusing optical fiber and configured to generate light having a second wavelength, wherein an intensity of light emitted from the second light source is adjustable;
wherein a color variation forms within the light-diffusing optical fiber at a junction of the light emitted from the first light source and the light emitted from the second light source;
   wherein the location of the color variation is adjustable along the light-diffusing optical fiber by adjusting intensity of light emitted from one or more of the first light source and the second light source

According to an embodiment is an illumination system including: (i) a light-diffusing optical fiber comprising a first input end and a second input end, the light-diffusing optical fiber having a glass core, a cladding surrounding the glass core, and an outer surface, and further comprising a plurality of nano-sized structures situated within the glass core or at a core-cladding boundary, the nano-sized structures being configured to scatter light; (ii) a first light source optically coupled to the first input end of the light-diffusing optical fiber and configured to generate light having a first wavelength, wherein the intensity of light emitted from the first light source is adjustable; and (iii) a second light source optically coupled to the second input end of the light-diffusing optical fiber and configured to generate light having a second wavelength, wherein the first wavelength, wherein the intensity of light emitted from the second light source is adjustable. An interface forms within the light-diffusing optical fiber at the junction of the light emitted from the first light source and the light emitted from the second light source, and the location of the interface is adjustable along the light-diffusing optical fiber by adjusting intensity of light emitted from one or more of the first light source and the second light source.

According to an embodiment, the system further includes a first potentiometer configured to control a power input to the first light source, a second potentiometer configured to control a power input to the second light source.

According to an embodiment, the first light source and the second light source are LEDs.

According to an embodiment, the optical fiber comprises a plurality of bends formed therein to preferentially scatter guided light via the nano-sized voids away from the core and through the outer surface.

According to an embodiment, the optical fiber has a length L of 0.5 m to 100 m.

According to an embodiment, the optical fiber is a multimode fiber, and includes: (i) a core diameter greater than 50 μm and less than 500 μm; and (ii) a numerical aperture NA>0.2.

According to an embodiment, the core of the light-diffusing optical fiber comprises silica and the nano-sized voids are situated in the core.

According to an embodiment, the nano-sized voids are situated in the core and the core has an outer diameter Rc, and the core comprises: a solid inner core section with radius R1, such that 0.1Rc<R1<0.9Rc, a nano-structured region having a width W2 wherein 0.05Rc<W2<0.9Rc, and an outer solid core region having a width Ws between 0.1Rc<Ws<0.9Rc, where each section of the core comprises silica glass.

According to an embodiment, the core comprises silica doped with at least one of the following dopants: Ge, F.

According to an embodiment, the entire core comprises nano-sized voids.

According to an embodiment, the cladding comprises either silica based glass or polymer.

According to an embodiment, the system further includes a coating disposed on the outer surface of the optical fiber, wherein fluorescent species are disposed in the optical fiber coating.

According to an embodiment, the light source generates light in 200-2000 nm wavelength range.

According to an embodiment, the optical fiber comprises at least one of pigment, phosphors, fluorescent material, UV absorbing material, hydrophilic material, light modifying material, or a combination thereof.

According to an aspect is an automobile comprising an illumination system including: (i) a light-diffusing optical fiber comprising a first input end and a second input end, the light-diffusing optical fiber having a glass core, a cladding surrounding the glass core, and an outer surface, and further comprising a plurality of nano-sized structures situated within the glass core or at a core-cladding boundary, the nano-sized structures being configured to scatter light; (ii) a first light source optically coupled to the first input end of the light-diffusing optical fiber and configured to generate light having a first wavelength, wherein the intensity of light emitted from the first light source is adjustable; and (iii) a second light source optically coupled to the second input end of the light-diffusing optical fiber and configured to generate light having a second wavelength, wherein the first wavelength, wherein the intensity of light emitted from the second light source is adjustable. An interface forms within the light-diffusing optical fiber at the junction of the light emitted from the first light source and the light emitted from the second light source, and the location of the interface is adjustable along the light-diffusing optical fiber by adjusting intensity of light emitted from one or more of the first light source and the second light source.

According to an aspect is an illumination system including: (i) a light-diffusing optical fiber comprising a first input end and a second input end, the light-diffusing optical fiber having a glass core, a cladding surrounding the glass core, and an outer surface, and further comprising a plurality of nano-sized structures situated within the glass core or at a core-cladding boundary, the nano-sized structures being configured to scatter light; (ii) a first light source optically coupled to the first input end of the light-diffusing optical fiber and configured to generate light having a first wavelength, wherein the intensity of light emitted from the first light source is adjustable; (iii) a second light source optically coupled to the second input end of the light-diffusing optical fiber and configured to generate light having a second wavelength, wherein the first wavelength, wherein the intensity of light emitted from the second light source is adjustable; (iv) a first potentiometer configured to control a power input to the first light source; and (v) a second potentiometer configured to control a power input to the second light source. An interface forms within the light-diffusing optical fiber at the junction of the light emitted from the first light source and the light emitted from the second light source, and the location of the interface is adjustable along the light-diffusing optical fiber by adjusting intensity of light emitted from one or more of the first light source and the second light source utilizing one or more of the first and second potentiometers.

According to an embodiment, the first light source and the second light source are LEDs.

According to an embodiment, the light sources generate light in 200-2000 nm wavelength range.

According to at least one embodiment is an illumination system including: (i) a light-diffusing optical fiber comprising a first input end and a second input end; (ii) a first light source optically coupled to the first input end of the light-diffusing optical fiber and configured to generate light having a first wavelength, wherein the intensity of light emitted from the first light source is adjustable; (iii) a second light source optically coupled to the second input end of the light-diffusing optical fiber and configured to generate light having a second wavelength, wherein the first wavelength, wherein the intensity of light emitted from the second light source is adjustable. An interface forms within the light-diffusing optical fiber at the junction of the light emitted from the first light source and the light emitted from the second light source, and the location of the interface is adjustable along the light-diffusing optical fiber by adjusting intensity of light emitted from one or more of the first light source and the second light source. That is, for example, at least one, and in some embodiments both of the light sources are configured to provide adjustable or varying light intensity(s). In some embodiments the intensity of the light provided by the light sources(s) can be adjusted by other means (e.g., a rotatable or slidable absorption filter that has different absorption characteristics in different locations).

According to an embodiment, the illumination system further includes a first potentiometer configured to control a power input to the first light source, and a second potentiometer configured to control a power input to the second light source.

According to an embodiment, the first light source and the second light source are LEDs.

As used herein for purposes of the present disclosure, terms such as “horizontal,” “vertical,” “front,” “back,” etc., and the use of Cartesian Coordinates are for the sake of reference in the drawings and for ease of description and are not intended to be strictly limiting either in the description or in the claims as to an absolute orientation and/or direction.

In the description of the disclosure below, the following terms and phrases are used in connection to light-diffusing optical fibers having nano-sized structures. The “refractive index profile” is the relationship between the refractive index or the relative refractive index and the waveguide (fiber) radius. The “relative refractive index percent” is defined as Δ(r)%=100×[n(r)²−n_{REF}²)]/2n(r)², where n(r) is the refractive index at radius r, unless otherwise specified. The relative refractive index percent is defined at 850 nm unless otherwise specified. In one aspect, the reference index n_{REF} silica glass with the refractive index of 1.452498 at 850 nm, in another aspect is the maximum refractive index of the cladding glass at 850 nm. As used herein, the relative refractive index is represented by Δ and its values are given in units of “%”, unless otherwise specified. In cases where the refractive index of a region is less than the reference index n_{REF}, the relative index percent is negative and is referred to as having a depressed region or depressed-index, and the minimum relative refractive index is calculated at the point at which the relative index is most negative unless otherwise specified. In cases where the refractive index of a region is greater than the reference index n_{REF}, the relative index percent is positive and the region can be said to be raised or to have a positive index.

The term “updopant” as used herein is considered to be a dopant which has a propensity to raise the refractive index relative to pure undoped SiO₂. The term “downdopant” as used herein is considered to be a dopant which has a propensity to lower the refractive index relative to pure undoped SiO₂. An updopant may be present in a region of an optical fiber having a negative relative refractive index when accompanied by one or more other dopants which are not updopants. Likewise, one or more other dopants which are not updopants may be present in a region of an optical fiber having a positive relative refractive index. A downdopant may be present in a region of an optical fiber having a positive relative refractive index when accompanied by one or more other dopants which are not downdopants. Likewise, one or more other dopants which are not downdopants may be present in a region of an optical fiber having a negative relative refractive index.

The term “α-profile” or “alpha profile” as used herein refers to refers to a relative refractive index profile, expressed in terms of Δ(r) which is in units of “%”, where r is radius, which follows the equation, Δ(r)=Δ(rₒ)(1−[|r−rₒ/(r₁−rₒ)]^{α}), where rₒ is the point at which Δ(r) is maximum, r₁ is the point at which Δ(r)% is zero, and r is in the range rᵢ≦r≦r_{f}, where Δ is defined above, rᵢ is the initial point of the α-profile, r_{f} is the final point of the α-profile, and α is an exponent which is a real number.

As used herein, the term “parabolic” therefore includes substantially parabolically shaped refractive index profiles which may vary slightly from an α value of 2.0 at one or more points in the core, as well as profiles with minor variations and/or a centerline dip. In some embodiments, α is greater than 1.5 and less than 2.5 In other embodiments, α is greater than 1.7 and less than 2.3. In yet other embodiments, α is between 1.8 and 2.3 when measured at 850 nm. In other embodiments, one or more segments of the refractive index profile have a substantially step index shape with an α value greater than 8. IN other embodiments, α is greater than 10 or greater than 20, when measured at 850 nm

The term “nano-structured fiber region” as used herein refers to describes the fiber having a region or area with a large number (greater than 50) of gas filled voids, or other nano-sized structures, e.g., more than 50, more than 100, or more than 200 voids in the cross-section of the fiber. The gas filled voids may contain, for example, SO₂, Kr, Ar, CO₂, N₂, O₂, or mixture thereof. The cross-sectional size (e.g., diameter) of nano-sized structures (e.g., voids) as described herein may vary from 10 nm to 1 μm (for example, 50 nm-500 nm), and the length may vary from 1 millimeter 50 meters (e.g., 2 mm to 5 meters, or 5 mm to 1 m range).

In standard single mode or multimode optical fibers, the losses at wavelengths less than 1300 nm are dominated by Rayleigh scattering. These Rayleigh scattering loss Ls is determined by the properties of the material and are typically about 20 dB/km for visible wavelengths (400-700 nm). Rayleigh scattering losses also have a strong wavelength dependence, which means that at least about 1 km to 2 km of the fiber is needed to dissipate more than 95% of the input light. Shorter lengths of such fiber would result in lower illumination efficiency, while using long lengths (1 km to 2 km, or more) can be more costly and can be difficult to manage. The long lengths of fiber, when used in a bioreactor or other illumination system may be cumbersome to install.

In certain configurations of lighting applications it is desirable to use shorter lengths of fiber, for example, 1-100 meters, although lengths significantly shorter than 1 meter and significantly longer than 100 meters are possible. This requires an increase of scattering loss from the fiber, while being able to maintain good angular scattering properties (uniform dissipation of light away from the axis of the fiber) and good bending performance to avoid bright spots at fiber bends. A desirable attribute of at least some of the embodiments of present disclosure described herein is high illumination along the length of the fiber illuminator. Because the optical fiber is flexible, it allows a wide variety of the illumination shapes to be deployed. There are substantially no bright spots (due to elevated bend losses) at the bending points of the fiber, such that the illumination provided by the fiber does not vary by more than 30%. In some embodiments the illumination variation is less than 20% and sometimes less than 10%. For example, in at least some embodiments, the average scattering loss of the fiber is greater than 50 dB/km, and the scattering loss does not vary more than 30% (i.e., the scattering loss is within ±30% of the average scattering loss) over any given fiber segment of 0.2 m length. According to at least some embodiments, the average scattering loss of the fiber is greater than 50 dB/km, and the scattering loss does not vary more than 30% over the fiber segments of less than 0.05 m length. According to at least some embodiments, the average scattering loss of the fiber is greater than 50 dB/km, and the scattering loss does not vary more than 30% (i.e., ±30%) over the fiber segments 0.01 m length. According to at least some embodiments, the average scattering loss of the fiber is greater than 50 dB/km, and the scattering loss does not vary more than 20% (i.e., ±20%) and in some embodiments by not more than 10% (i.e., ±10%) over the fiber segments 0.01 m length.

In at least some embodiments, the intensity variation of the integrated (diffused) light intensity coming through sides of the fiber at the illumination wavelength is less than 30%/o for target length of the fiber, which can be, for example, 0.02-100 m length. It is noted that the intensity of integrated light intensity through sides of the fiber at a specified illumination wavelength can be varied by incorporating fluorescence material in the cladding or coating. The wavelength of the light scattering by the fluorescent material is different from the wavelength of the light propagating in the fiber.

In some the following exemplary embodiments there is described fiber designs with a nano-structured fiber region (region with nano-sized structures) placed in the core area of the fiber, or very close to core. Some of the fiber embodiments have scattering losses in excess of 50 dB/km (for example, greater than 100 dB/km, greater than 200 dB/km, greater than 500 dB/km, greater than 1000 dB/km, greater than 3000 dB/km, greater than 5000 dB/km), the scattering loss (and thus illumination, or light radiated by these fibers) is uniform in angular space.

In order to reduce or to eliminate bright spots as bends in the fiber, it is desirable that the increase in attenuation at a 90° bend in the fiber is less than 5 dB/turn (for example, less than 3 dB/turn, less than 2 dB/turn, less than 1 dB/turn) when the bend diameter is less than 50 mm. In an exemplary embodiment, the low bend losses are achieved at even smaller bend diameters, for example, less than 20 mm, less than 10 mm, and even less than 5 mm. The total increase in attenuation is less than 1 dB per 90 degree turn, at a bend radius of 5 mm.

According to some embodiments, the bending loss is equal to or is lower than intrinsic scattering loss from the core of the straight fiber. The intrinsic scattering is predominantly due to scattering from the nano-sized structures. Thus, according to at least the bend insensitive embodiments of optical fiber, the bend loss does not exceed the intrinsic scattering for the fiber. However, because the scattering level is a function of bending diameter, the bending deployment of the fiber depends on its scattering level. For example, in some of the embodiments, the fiber has a bend loss less than 3 dB/turn, and in some embodiments, less than 2 dB/turn, and the fiber can be bent in an arc with a radius as small as 5 mm radius without forming bright spots.

Also, in the description below, in some embodiments where it is said that scattered actinic light is provided or delivered throughout a photoreactive material, the scattered actinic light is assumed to have sufficient intensity to perform a photoreaction on the photoreactive material in a reasonable period of time.

These and other aspects of the invention will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a schematic side view of a section of a light-diffusing optical fiber in accordance with an embodiment;

FIG. 2 is a schematic cross-section of the optical fiber of FIG. 1 as viewed along the direction 2-2;

FIG. 3A is a schematic illustration of relative refractive index plot versus fiber radius for a light-diffusing fiber in accordance with an embodiment;

FIG. 3B is a schematic illustration of relative refractive index plot versus fiber radius for a light-diffusing fiber in accordance with an embodiment;

FIG. 3C is a schematic illustration of a light-diffusing optical fiber in accordance with an embodiment;

FIG. 4 is a schematic illustration of a light-diffusing optical fiber in accordance with an embodiment;

FIG. 5 is a schematic illustration of a color front within a light-diffusing optical fiber in accordance with an embodiment;

FIG. 6 is a schematic illustration of color front movement within a light-diffusing optical fiber in accordance with an embodiment; and

FIG. 7 is a schematic illustration of color front movement within a light-diffusing optical fiber in accordance with an embodiment.

### DETAILED DESCRIPTION OF EMBODIMENTS

The present disclosure describes various embodiments of apparatus, systems, and devices that produce the appearance of color movement along the length of a light-diffusing optical fiber. Although the light and colors emitted from existing bend insensitive light-diffusing optical fibers are largely static, Applicants have recognized that it would be beneficial to create the appearance of movement along the length of the light-diffusing optical fiber.

In view of the foregoing, various embodiments and implementations are directed to an illumination system designed to create the appearance of light movement includes a light-diffusing optical fiber with light sources optically connected to the fiber at each end. The two light sources emit light of different wavelengths and adjustable intensity, which meet at a junction along the length of the optical fiber. The appearance of movement is created by adjusting the intensity of the light emitted by one or both of the two light sources, which changes the location of the junction along the length of the optical fiber.

Reference is now made in detail to the present preferred embodiments of the disclosure, examples of which are illustrated in the accompanying drawings. Whenever possible, like or similar reference numerals are used throughout the drawings to refer to like or similar parts. It should be understood that the embodiments disclosed herein are merely examples, each incorporating certain benefits of the present disclosure.

Various modifications and alterations may be made to the following examples within the scope of the present disclosure, and aspects of the different examples may be mixed in different ways to achieve yet further examples. Accordingly, the true scope of the disclosure is to be understood from the entirety of the present disclosure, in view of but not limited to the embodiments described herein.

Light-Diffusing Optical Fiber

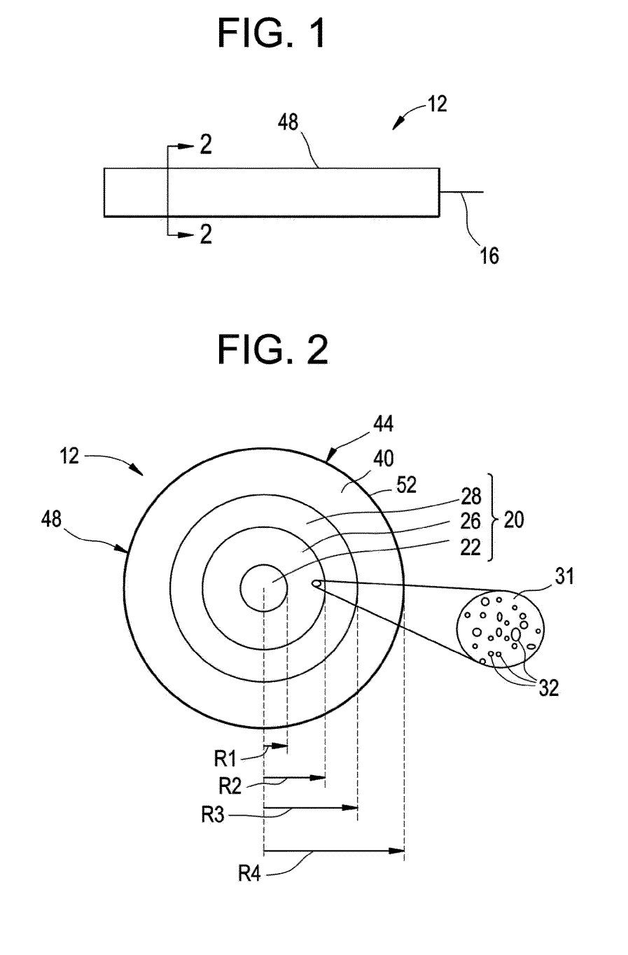

Referring now to FIG. 1A, a schematic side view of a section of an example embodiment of a light-diffusing fiber is disclosed. A plurality of voids are disposed in the core of the light-diffusing optical fiber (hereinafter “fiber”) 12 having a central axis (“centerline”) 16.

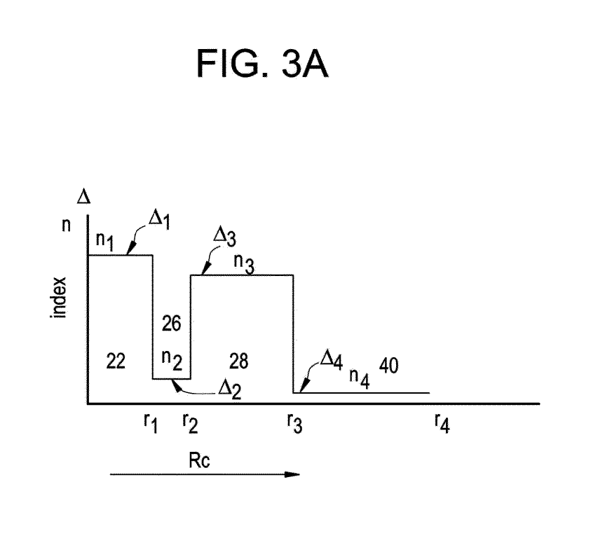

FIG. 2 is a schematic cross-section of an embodiment of light-diffusing optical fiber 12 as viewed along the direction 2-2 in FIG. 1. Light-diffusing fiber 12 can be, for example, any one of the various types of optical fiber with a nano-structured fiber region having periodic or non-periodic nano-sized structures 32 (for example voids). In an example embodiment, fiber 12 includes a core 20 divided into three sections or regions. These core regions can be, for example: a solid central portion 22, a nano-structured ring portion (inner annular core region) 26, and outer, solid portion 28 surrounding the inner annular core region 26. A cladding region 40 (“cladding”) surrounds the annular core 20 and has an outer surface. The cladding 40 may have low refractive index to provide a high numerical aperture (NA). The cladding 40 can be, for example, a low index polymer material, such as UV or thermally curable fluoroacrylate or silicone.

An optional coating 44 surrounds the cladding 40. Coating 44 may include a low modulus primary coating layer and a high modulus secondary coating layer. In some embodiments, coating layer 44 comprises a polymer coating such as an acrylate-based or silicone based polymer. In other embodiments, the coating has a constant diameter along the length of the fiber. In some exemplary embodiments, coating 44 is designed to enhance the distribution and/or the nature of “radiated light” that passes from core 20 through cladding 40. The outer surface of the cladding 40, or the of the outer of optional coating 44, represents the “sides” 48 of fiber 12 through which light traveling in the fiber is made to exit via scattering, as described herein. A protective cover or sheath (not shown) optionally covers cladding 40. Fiber 12 may include a fluorinated cladding 40, but the fluorinated cladding is not needed if the fibers are to be used in short-length applications where leakage losses do not degrade the illumination properties.

In some exemplary embodiments, the core region 26 of light-diffusing fiber 12 comprises a glass matrix (“glass”) 31 with a plurality of non-periodically disposed nano-sized structures (e.g., “voids”) 32 situated therein, such as the example voids shown in detail in the magnified inset of FIG. 2. In another example embodiment, voids 32 may be periodically disposed, such as in a photonic crystal optical fiber, wherein the voids typically have diameters between about 1×10⁻⁶ m and 1×10⁻⁵ m. Voids 32 may also be non-periodically or randomly disposed in the material. In some exemplary embodiment, glass 31 in region 26 is fluorine-doped silica, while in other embodiment the glass is undoped pure silica. The diameters of the voids are at least 10 nm.

The nano-sized structures 32 scatter the light away from the core 20 and toward the outer surface of the fiber. The scattered light is then “diffused” through the outer surface of the fiber 12 to provide the desired illumination. That is, most of the light is diffused (via scattering) through the sides of the fiber 12, along the fiber length. The fiber can have a scattering-induced attenuation of greater than 50 dB/km in the wavelength(s) of the emitted radiation (illumination wavelength). The scattering-induced attenuation is greater than 100 dB/km for this wavelength. In some embodiments, the scattering-induced attenuation is greater than 500 dB/km at this wavelength, and in some embodiments the scattering-induced attenuation can be, e.g., 1000 dB/km, greater than 2000 dB/km, or greater than 5000 dB/km.

These high scattering losses are about 2.5 to 250 times higher than the Rayleigh scattering losses in standard single mode and multimode optical fibers.

Glass in core regions 22 and 28 may include updopants, such as Ge, Al, and/or P. By “non-periodically disposed” or “non-periodic distribution,” it is meant that when one takes a cross-section of the optical fiber (such as shown in FIG. 2), the voids 32 are randomly or non-periodically distributed across a portion of the fiber. Similar cross sections taken at different points along the length of the fiber will reveal different cross-sectional void patterns, i.e., various cross sections will have different voids patterns, wherein the distributions of voids and sizes of voids do not match. That is, the voids are non-periodic, i.e., they are not periodically disposed within the fiber structure. These voids are stretched (elongated) along the length (i.e. parallel to the longitudinal axis) of the optical fiber, but do not extend the entire length of the entire fiber for typical lengths of transmission fiber. While not wishing to be bound by theory, it is believed that the voids extend less than 10 meters, and in many cases less than 1 meter along the length of the fiber.

The light-diffusing fiber 12 as used herein in the illumination system discussed below can be made by methods which utilize preform consolidation conditions which result in a significant amount of gases being trapped in the consolidated glass blank, thereby causing the formation of voids in the consolidated glass optical fiber preform. Rather than taking steps to remove these voids, the resultant preform is used to form an optical fiber with voids, or nano-sized structures, therein. The resultant fiber's nano-sized structures or voids are utilized to scatter or guide the light out of the fiber, via its sides, along the fiber length. That is, the light is guided away from the core 20, through the outer surface of the fiber, to provide the desired illumination.

As described above, in some embodiments of fiber 12, core sections 22 and 28 comprise silica doped with germanium, i.e., germanium-doped silica. Dopants other than germanium, singly or in combination, may be employed within the core, and particularly at or near the centerline 16, of the optical fiber to obtain the desired refractive index and density.

In at least some embodiments, the relative refractive index profile of the optical fiber disclosed herein is non-negative in core sections 22 and 28. In at least some embodiments, the optical fiber contains no index-decreasing dopants in the core. In some embodiments, the relative refractive index profile of the optical fiber disclosed herein is non-negative in sections 22 and 28.

In some examples of fiber 12 as used herein, the core 20 comprises pure silica. In one embodiment, a preferred attribute of the fiber is the ability to scatter light out of the fiber (to diffuse light) in the desired spectral range to which biological material is sensitive. In another embodiments, the scattered light may be used for decorative accents and white light applications. The amount of the loss via scattering can be increased by changing the properties of the glass in the fiber, the width of the nano-structured region 26, and the size and the density of the nano-sized structures.

In some embodiments of the fiber 12, core 20 is a graded-index core, and the refractive index profile of the core has a parabolic (or substantially parabolic) shape; in some embodiments, e.g., the refractive index profile of core 20 has an α-shape with an α value of about 2, and in some cases between 1.8 and 2.3 as measured at 850 nm. In other embodiments, one or more segments of the refractive index profile have a substantially step index shape with an α value greater than 8, and in some cases greater than 10, or greater than 20, as measured at 850 nm. In some embodiments, the refractive index of the core may have a centerline dip, wherein the maximum refractive index of the core, and the maximum refractive index of the entire optical fiber, is located a small distance away from centerline 16, but in other embodiments the refractive index of the core has no centerline dip, and the maximum refractive index of the core, and the maximum refractive index of the entire optical fiber, is located at the centerline.

In an exemplary embodiment, fiber 12 has a silica-based core 20 and depressed index (relative to silica) polymer cladding 40. The low index polymer cladding 40 can have a relative refractive index that is negative, and in some cases be less than −0.5%, or less than −1%. In some exemplary embodiments cladding 40 has thickness of 20 μm or more. In some exemplary embodiments cladding 40 has a lower refractive index than the core, and a thickness of 10 μm or more (e.g., 20 μm or more). In some exemplary embodiments, the cladding has an outer diameter 2 times Rmax, e.g., about 125 μm (e.g., 120 μm to 130 μm, or 123 μm to 128 μm). In other embodiments the cladding has a diameter that is less than 120 μm, for example 60 or 80 μm. In other embodiments the outer diameter of the cladding is greater than 200 μm, greater than 300 μm, or greater than 500 pin. In some embodiments, the outer diameter of the cladding has a constant diameter along the length of fiber 12. In other embodiments, the refractive index of fiber 12 has radial symmetry. The outer diameter of core 20 is substantially constant along the length of the fiber and the outer diameters of core sections 22, 26, 28 are also substantially constant along the length of the fiber. The use term “substantially constant” in this section means that the variations in the diameter with respect to the mean value can be less than 10% in some embodiments, less than 5% in other embodiments, and less than 2% in yet other embodiments.

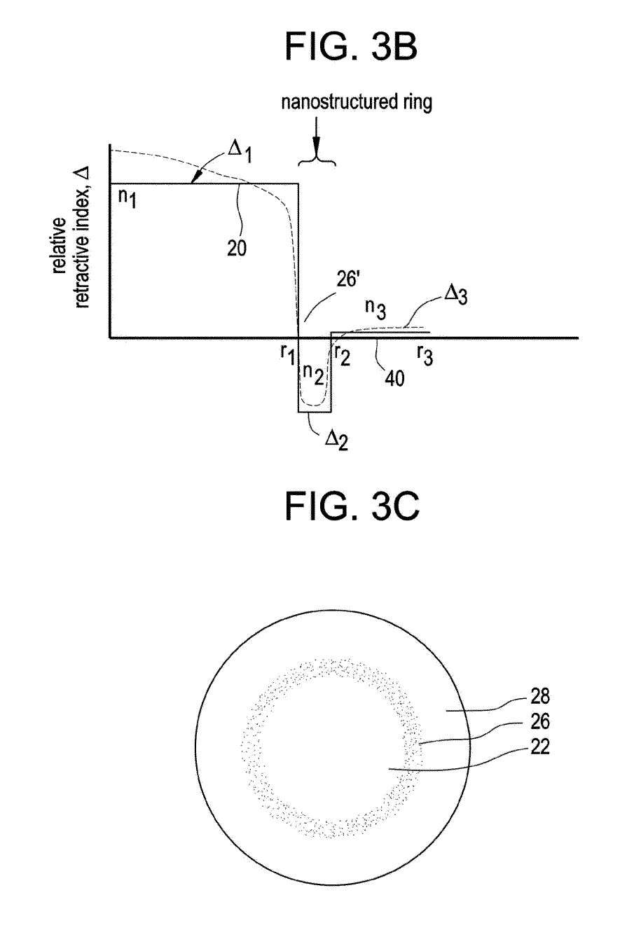

FIG. 3A is a plot of the exemplary relative refractive index Δ versus fiber radius for an example fiber 12 shown in FIG. 2 (solid line). The core 20 may also have a graded core profile, characterized, for example, by an α-value between 1.7 and 2.3 (e.g., 1.8 to 2.3). Core region 22 extends radially outwardly from the centerline to its outer radius, R1, and has a relative refractive index profile Δ₁(r) corresponding to a maximum refractive index n1 (and relative refractive index percent Δ_{1MAX}). In this embodiment, the reference index n_{REF} is the refractive index at the cladding. The second core region (nano-structured region) 26 has minimum refractive index n2, a relative refractive index profile Δ2(r), a maximum relative refractive index Δ2_{MAX}, and a minimum relative refractive index Δ2_{MIN}, where in some embodiments Δ2_{MAX}=Δ2_{MIN}. The third core region 28 has a maximum refractive index n3, a relative refractive index profile Δ3(r) with a maximum relative refractive index Δ3_{MAX} and a minimum relative refractive index Δ3_{MIN}, where in some embodiments Δ3_{MAX}=Δ3_{MIN}. In this embodiment the annular cladding 40 has a refractive index n4, a relative refractive index profile Δ4(r) with a maximum relative refractive index Δ4_{MAX}, and a minimum relative refractive index Δ4_{MIN}. In some embodiments Δ4_{MAX}=Δ4_{MIN}. In some embodiments, Δ1 _{MAX}>Δ4_{MAX} and Δ3_{MAX}>Δ4_{MAX}. In some embodiments Δ2_{MIN}>Δ4_{MAX}. In the embodiment shown in FIGS. 2 and 3A, Δ1_{MAX}>Δ3_{MAX}>Δ2_{MAX}>Δ4_{MAX}. In this embodiment the refractive indices of the regions have the following relationship n1>n3>n2>n4.

In some embodiments, core regions 22, 28 have a substantially constant refractive index profile, as shown in FIG. 3A with a constant Δ1 (r) and Δ3(r). In some of these embodiments, Δ2(r) is either slightly positive (0<Δ2(r)<0.1%), negative (−0.1%<Δ2(r)<0), or 0%. In other embodiments the absolute magnitude of Δ2(r) is less than 0.1%, substantially less than 0.05%. In yet other embodiments, the outer cladding region 40 has a substantially constant refractive index profile, as shown in FIG. 3A, with a constant Δ4(r). In some of these embodiments, Δ4(r)=0%. The core section 22 has a refractive index where Δ1(r)≧0%. In some embodiments, the void-filled region 26 has a relative refractive index profile Δ2(r) having a negative refractive index with absolute magnitude less than 0.05%, and Δ3(r) of the core region 28 can be, for example, positive or zero. In at least some embodiments, n1>n2 and n3>n4.

In some embodiments the cladding 40 has a refractive index −0.05%<Δ4(r)<0.05%. In other embodiments, the cladding 40 and the core portions portion 20, 26, and 28 may comprise pure (undoped) silica. The cladding 40 may alternatively comprise pure low index polymer. In some embodiments, nano-structured region 26 comprises pure silica comprising a plurality of voids 32. The minimum relative refractive index and the average effective relative refractive index—taking into account the presence of any voids—of nano-structured region 26 are both less than −0.1%. The voids or voids 32 may contain one or more gases, such as argon, nitrogen, oxygen, krypton, or SO₂ or can contain a vacuum with substantially no gas. However, regardless of the presence or absence of any gas, the average refractive index in nano-structured region 26 is lowered due to the presence of voids 32. Voids 32 can be randomly or non-periodically disposed in the nano-structured region 26, and in other embodiments, the voids are disposed periodically therein. In some embodiments, the plurality of voids 32 comprises a plurality of non-periodically disposed voids and a plurality of periodically disposed voids.

In example embodiments, core section 22 comprises germanium doped silica, core inner annular region 28 comprises pure silica, and the cladding annular region 40 comprises a glass or a low index polymer. In some of these embodiments, nano-structured region 26 comprises a plurality of voids 32 in pure silica; and in yet others of these embodiments, nano-structured region 26 comprises a plurality of voids 32 in fluorine-doped silica.

In some embodiments, the outer radius, Rc, of core is greater than 10 μm and less than 600 μm. In some embodiments, the outer radius Rc of core is greater than 30 μm and/or less than 400 μm. For example, Rc may be 125 μm to 300 μm. In other embodiments, the outer radius R_{c} of the core 20 is larger than 50 μm and less than 250 μm. The central portion 22 of the core 20 has a radius in the range 0.1Rc<R₁<0.9R_{c}, and in some cases 0.5Rc<R₁<0.9Rc. The width W2 of the nano-structured ring region 26 can be 0.05Rc<W2<0.9Rc, and in some cases 0.1Rc<W2<0.9Rc, and in other embodiments 0.5Rc<W2<0.9Rc (a wider nano-structured region gives a higher scattering-induced attenuation, for the same density of nano-sized structures). The solid glass core region 28 has a width Ws=W3 such that 0.1Rc<W3<0.9Rc. Each section of the core 20 comprises silica based glass. The radial width W2 of nano-structured region 26 can be greater than 1 μmin. For example, W2 may be 5 μm to 300 μm, or in some cases 200 μm or less. In some embodiments, W2 is greater than 2 μm and less than 100 μm. In other embodiments, W2 is greater than 2 μm and less than 50 μm. In other embodiments, W2 is greater than 2 μm and less than 20 μm. In other embodiments, W2 is at least 7 μm. In yet other embodiments, W2 is greater than 2 μm and less than 12 μm. The width W3 of core region 28 is (R3−R2) and its midpoint R3_{MID} is (R2+R3)/2. In some embodiments, W3 is greater than 1 um and less than 100 μm.

The numerical aperture (NA) of fiber 12 can be equal to, or greater than, the NA of a light source directing light into the fiber. The numerical aperture (NA) of fiber 12 can be greater than 0.2, in some embodiments greater than 0.3, and in others greater than 0.4.

In some embodiments, the core outer radius R1 of the first core region 22 is not less than 24 μm and not more than 50 μm, i.e. the core diameter is between about 48 and 100 μm. In other embodiments, R1>24 microns; in still other embodiments, R1>30 microns; in yet other embodiments, R1>40 microns.

In some embodiments, |Δ₂(r)|<0.025% for more than 50% of the radial width of the annular inner portion 26, and in other embodiments |Δ₂(r)|<0.01% for more than 50% of the radial width of region 26. The depressed-index annular portion 26 begins where the relative refractive index of the cladding first reaches α value of less than −0.05%, going radially outwardly from the centerline. In some embodiments, the cladding 40 has a relative refractive index profile Δ4(r) having a maximum absolute magnitude less than 0.1%, and in this embodiment Δ4_{MAX}<0.05% and Δ4_{MIN}>−0.05%, and the depressed-index annular portion 26 portion ends where the outermost void is found.

The cladding structure 40 extends to a radius R4, which is also the outermost periphery of the optical fiber. In some embodiments, the width of the cladding, R4−R3, is greater than 20 μm; in other embodiments R4−R3 is at least 50 μm, and in some embodiments, R4−R3 is at least 70 μm. In another embodiment, the entire core 20 is nano-structured (filled with voids, for example), and the core 20 is surrounded by the cladding 40. The core 20 may have a “step” refractive index delta, or may have a graded core profile, with α-profile having, for example, α-value between 1.8 and 2.3.

Referring to FIG. 3B, a schematic of another embodiment of light-diffusing fiber 12 is disclosed. The fiber of FIG. 3B includes a core 20 with a relative refractive index Δ₁, a nano-structured region 26′ situated over and surrounding the core 20. The core 20 may have a “step” index profile, or a graded core profile, with α-profile having, for example, α-value between 1.8 and 2.3. In this embodiment, the nano-structured region 26′ is an annular ring with a plurality of voids 32. In this embodiment, the width of region 26′ can be as small as 1-2 um, and may have a negative average relative refractive index Δ₂. Cladding 40 surrounds the nano-structured region 26′. The (radial) width of cladding 40 may be as small as 1 μm, and the cladding may have either a negative, a positive or 0% relative refractive index, (relative to pure silica). The main difference between the examples in FIGS. 3A and 3B is that nano-structured region shown in FIG. 3A is located in the core 20 of the light-diffusing fiber 12, and in FIG. 3B it is located at the core/clad interface. The depressed-index annular portion 26′ begins where the relative refractive index of the core first reaches α value of less than −0.05%, going radially outwardly from the centerline. In the embodiment of FIG. 3B, the cladding 40 has a relative refractive index profile Δ3(r) having a maximum absolute magnitude less than 0.1%, and in this embodiment Δ3_{MAX}<0.05% and Δ3_{MIN}>−0.05%, and the depressed-index annular portion 26 ends where the outmost void occurs in the void-filled region. In the embodiment shown in FIG. 3B, the index of refraction of the core 20 is greater than the index of refraction n2 of the annular region 26′, and the index of refraction n1 of the cladding 40 is also greater than the index of refraction n2.

FIG. 3C illustrates one embodiment of a core 20 of optical fiber 12. This fiber has a first core region 22 with an outer radius R1 of about 33.4 μm, a nano-structured region 26 with an outer radius R2=42.8 μm, a third core region 28 with an outer radius R3=62.5 μm, and a polymer cladding 40 with an outer radius R4 (not shown) of 82.5 μm). In this embodiment, the material of the core is pure silica (undoped silica), the material for cladding was low index polymer (e.g., UV curable silicone having a refractive index of 1.413 available from Dow-Corning of Midland, Mich. under product name Q3-6696) which, in conjunction with the glass core, resulted in fiber NA of 0.3. The optical fiber 12 had a relatively flat (weak) dependence on wavelength, compared to standard single-mode transmission fiber, such as for example SMF-28e® fiber. In standard single mode (such as SMF-28®) or multimode optical fibers, the losses at wavelengths less than 1300 nm are dominated by Rayleigh scattering. These Rayleigh scattering losses are determined by the properties of the material and are typically about 20 dB/km for visible wavelengths (400-700 nm). The wavelength dependence of Rayleigh scattering losses is proportional to λ^{-p} with p≈4. The exponent of the wavelength dependent scattering losses in the fiber comprising at least one nanostructured region is less than 2, and can be less than 1 over at least 80% (for example greater than 90%) in the 400 nm-1100 nm wavelength range. The average spectral attenuation from 400 nm to 1100 nm was about 0.4 dB/m when the fiber was drawn with at 40 g tension and was about 0.1 dB/m when the fiber 12 was drawn at 90 g tension. In this embodiment, the nano-sized structures contain SO₂ gas. Applicants found that voids filled with SO₂ in the nano-structured ring greatly contribute to scattering. Furthermore, when SO₂ gas was used to form the nano-structures, the gas allows a thermally reversible loss to be obtained, i.e., below 600° C. the nano-structured fiber scatters light, but above 600° C., the same fiber will guide light. This unique behavior that SO₂ imparts is also reversible, in that upon cooling the same fiber below 600° C., the fiber 12 will act as light-diffusing fiber and will again generate an observable scattering effect.

The presence of the nano-sized structures in the light-diffusing fiber 12 creates losses due to optical scattering, and the light scattering through the outer surface of the fiber can be used for illumination purposes.

Coatings

In an example embodiment, fiber 12 may include a coating 44 as discussed above in connection with FIG. 2. In one exemplary embodiment, coating 44 includes a hydrophilic coating layer such as a UV-cured acrylate coating that provides improved wet adhesion. The coating layer may be UV curable coatings comprising a low modulus primary coating layer (typically <3 MPa) adjacent to the glass and a higher modulus secondary coating layer (typically >50 MPa). The higher modulus secondary coating layer is adjacent to, and situated over, the primary (lower modulus) coating layer. Other, or additional coatings, applied either as a single layer coating or as a layer in a multi-layer coating may also be utilized. Examples of such materials are hydrophilic coating 44A (not shown) which serves as a cell growth medium or a coating containing a material to provide additional scattering to the escaped light. These coatings may also serve as a protective covering for the fiber 12.

Exemplary hydrophilic coatings 44A for use in coating 44 are those commonly used for improving cell adhesion and growth to surfaces and contain carboxylic acid functionality and amine functionality (e.g. formulations containing acrylic acid or acrylamides). In addition, hydrophilic coatings 44A may be enhanced by serving as a reservoir for nutrients essential for the growth of biological material.

In some exemplary embodiments, coating 44 includes fluorescent or ultraviolet absorbing molecules that serve to modify radiated light. Suitable up or down converter molecules may also be included in the coating to produce light of differing wavelengths from that of the input light source. Ink coating layers may also be applied to alter the color or hue of the emitted light. Other coating embodiments include molecules capable of providing additional scattering to the light emitted from the fiber. A further embodiment may be the inclusion of photo-active catalysts onto the coating that may be used to increase the rate of photo-reactions. One example of just such a catalyst is rutile TiO₂, as a photo-catalyst.

According to some embodiments, light-diffusing fibers 12 may be enclosed within a polymeric, metal, or glass covering (or coatings), wherein said the coating or covering has a minimum outer dimension (e.g., diameter) greater than 250 μm. If the fiber(s) has a metal coating, the metal coating may contain open sections, to allow light to be preferentially directed into a given area. These additional coatings or coverings may also contain additional compounds to vary the emitted light or catalyze reactions in the same manner as described above for the coatings coated on the fiber.

As stated above, the light-diffusing fiber 12 may comprise a hydrophilic coating disposed on the outer surface of the optical fiber. Also, fluorescent species (e.g., ultraviolet-absorbing material) may be disposed in the optical fiber coating, as well as molecules capable of providing additional scattering of the emitted light. According to some embodiments the light source coupled to the light-diffusing fiber 12 generates light in 200 nm to 500 nm wavelength range and the fluorescent material (fluorescent species) in the fiber coating generates either white, green, red, or NIR (near infrared) light.

Furthermore, an additional coating layer may be provided on the fiber outer surface. This layer may be configured to modify the radiated light, alter the interaction of the coating materials. Examples of just such a coating would be coatings containing materials such as, but not limited to, poly (2-acrylamido-2-methanesulfonic acid), ortho-nitrobenzyl groups, or azobenzene moities respectively.

Illumination Systems for Color Front Movement

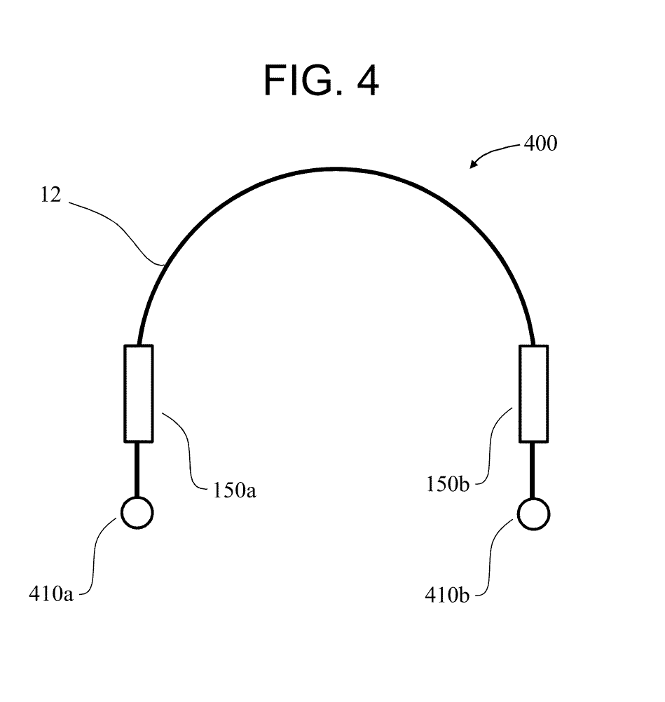

Referring to FIG. 4 is an embodiment of an illumination system 400 for color front movement. Illumination system 400 includes a light-diffusing optical fiber 12, which can be, for example, any of the optical fiber embodiments described or otherwise envisioned herein. As just a few examples, light-diffusing optical fiber 12 can be a bend insensitive optical fiber, or may comprise a plurality of light-diffusing fibers. Cable designs which are assemblies of multiple fibers are well known and could include ribbons, collections of multiple ribbons, or fibers gathered into a tube, among many, many other structures and configurations. Such fibers may include one or more light-diffusing fibers. Movement of the color front can also be realized in other types of light diffusing elements for which light of different colors can be injected into each end. Such light diffusing elements can include plastic optical fibers or hybrid fibers using both glass and plastic within which some sort of scattering mechanism is introduced such as air lines, inclusions consisting of foreign materials like titanium dioxide or mechanical flaws in the waveguide. Other potential light diffusing elements are molded or extruded plastic or glass structures with one or more of the scattering mechanisms mentioned above.

For example, as described herein, fiber 12 can be a light-diffusing fiber comprising a core, cladding, and a plurality of nano-sized structures situated within the core or at a core-cladding boundary. This optical fiber can further include an outer surface. As described above, the light-diffusing optical fiber 12 is configured to scatter guided light via the nano-sized structures such as voids away from the core and through the outer surface, to form a light-source fiber portion that emits radiation over its length. The fiber 12 may have a plurality of bends formed therein so as to preferentially scatter light via the nano-sized structures 32 away from the core 20 and through the outer surface within specified area(s).

Referring again to FIG. 4, illumination system 400 also includes a first light source 150a which is optically coupled to a first end of the optical fiber 12, and a second light source 150b optically coupled to a second end of the optical fiber 12. The light sources may be any of a wide variety of light sources, including but not limited to light emitting diodes (LED). According to some embodiments the light sources generate light having at least one wavelength λ within the 200 nm to 2000 nm range.

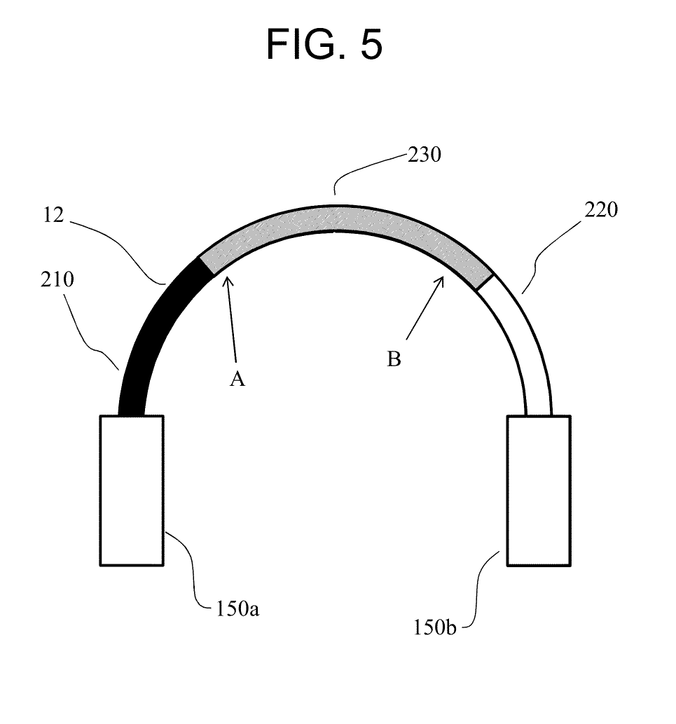

According to an embodiment depicted in FIG. 5, the first light source emits light having a first wavelength 210, and the second light source emits light having a second wavelength 220. First wavelength 210 and second wavelength 220 are usually different wavelengths. For example, if the intensities of the light emitted by the first and second light sources are approximately equal, the light will form a color variation 230 at the overlap of the light emitted from the first light source and the light emitted from the second light source.

Although color change 230 is depicted as a solid color in the figures, it will be appreciated by one of skill in the art that the specific color and/or intensity of color variation 230 can vary at any point along the length of the interaction between light emitted from the first light source and the light emitted from the second light source. For example, referring to FIG. 5, the color of light at a first location A of color variation 230 might be different than the color of light at a second location B of color variation 230. According to an embodiment, the color observed by a user at a specific location of color variation 230 along optical fiber 12 will correspond to the color on the CIE color map on a line drawn between the two points corresponding to the wavelength of light emitted by light source 150a and the wavelength of light emitted by light source 150b. The color variation is due to a variety of factors, including but not limited to the values of first wavelength 210 and second wavelength 220, the distance of the observed location (for example, A or B) of color variation 230 from one or both of light sources 150a and 150b, and/or a variety of other factors.

According to one embodiment, for example, light source 150a can emit light having a wavelength of 638 nm (red) and light source 150b can emit light having a wavelength of 445 nm (blue). The color observed at any point along color variation 230 will correspond to the colors on the CIE color map on a line drawn between 445 nm and 638 nm. Which point along the line drawn on the CIE color map between 445 and 638 nm is observed at a location along color variation 230 depends on, for example, the balance of the power level of light source 150a and 150b. For example, if the red light source (150a) is set to a much higher power than the blue light source (150b), the optical fiber 12 will show only the colors along a subset of the line which are closest to the red laser point, and vice versa.

First wavelength 210 and second wavelength 220 are typically adjustable, such that the color of the light emitted by the first and second light sources can be varied in addition to creating the sense of movement along fiber 12.

To create the appearance of movement within optical fiber 12, the first and second light sources are configured to comprise adjustable intensities. For example, the intensity of the light emitted by the first and second light sources can be controlled by a controller, which in turn sends instructions to a light driver. The controller can be directed by preprogrammed instructions, or can respond to user input, sensor input, time, or a wide variety of other control inputs.

According one embodiment depicted in FIG. 4, first light source 150a includes a potentiometer 410a that controls the power input to the first light source. Second light source 150b similarly includes a potentiometer 410b that controls the power input to the second light source. Potentiometers 410a and 410b can be individually controlled to independently direct the power input to the first and second light sources, respectively. The potentiometers can be controlled electronically, and/or remotely, using any of a wide variety of control mechanisms. For example, the potentiometers can be a component in a system-wide control circuit. The control circuit can be directed by or respond to preprogrammed instructions, or can respond to user input, sensor input, time, or a wide variety of other control inputs. Alternatively, one or more of the potentiometers can be controlled by a switch, knob, or other direct controls means. This would allow a user to directly adjust the intensity of the light emitted by the first and/or second light source. Alternatively, the drivers which set the drive currents of the individual light sources and, hence, their output powers, can be controlled by analog voltages and/or pulse-width modulation (“PWM”) signals, among other variations. These voltages or PWM signals can be generated by a microcontroller which is programmed to deliver the desired color movement effect. Power balance, rate of change and magnitude of change are some of the parameters that can be controlled by a microcontroller. The microcontroller can also be interfaced to a system that receives commands from a remote control. These commands can adjust the parameters mentioned above or they can cycle through a collection of pre-programmed effects.

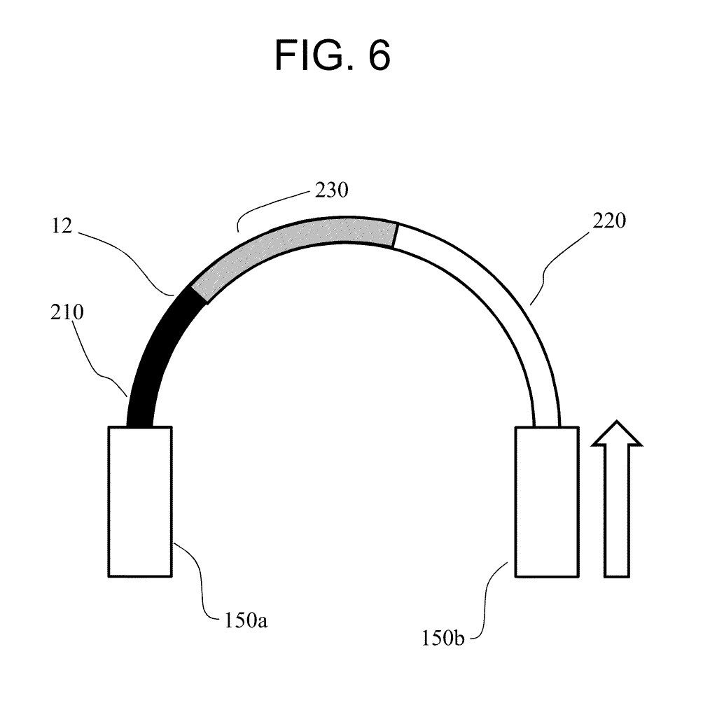

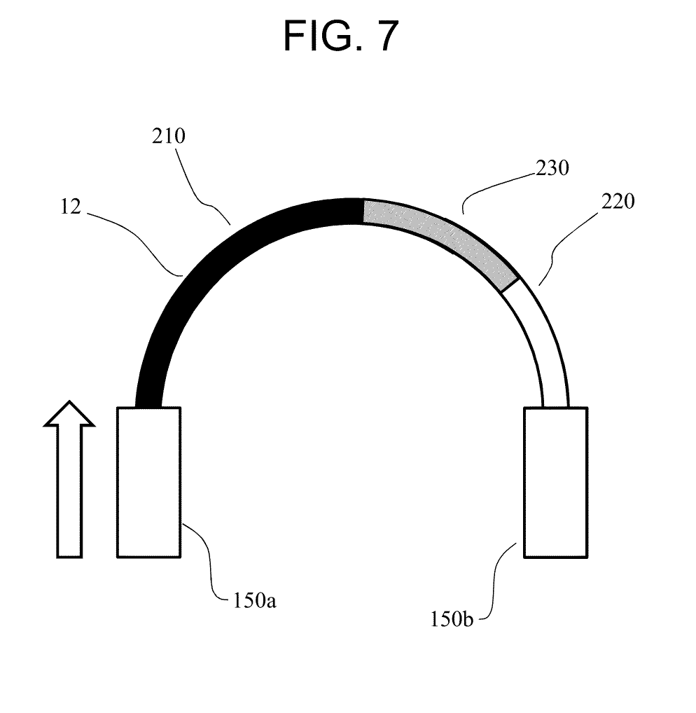

To create the appearance of movement along the length of optical fiber 12, the intensity of the light emitted by the first and/or second light sources is adjusted. Movement of color variation 230 is depicted in FIGS. 6-7. In FIG. 6, for example, the intensity of light having wavelength 220 emitted by light source 150b is increased. This can be accomplished, for example, by directing potentiometer 410b to increase power to light source 150b, which in turn increases the intensity of the light emitted by light source 150b. In addition to increasing the intensity of the light emitted by light source 150b, the intensity of the light emitted by light source 150a may be simultaneously decreased. Alternatively, the intensity of the light emitted by light source 150a may be decreased. Intensity of light emitted by light source 150a can be controlled, for example, by directing potentiometer 410a.

Increasing the intensity of the light emitted by light source 150b, and/or decreasing the intensity of the light emitted by light source 150a, causes color variation 230 at the interplay of the light emitted from the first light source and the light emitted from the second light source to move from approximately center in FIG. 5 to the left toward light source 150a. The rate at which the intensity of light is adjusted will also control the rate at which interface 230 moves along the length of optical fiber 12. Slowly increasing or decreasing the intensity of one or more of light sources 150a and/or 150b will cause color variation 230 to move slowly along the length of optical fiber 12, while quickly increasing or decreasing the intensity of one or more of light sources 150a and/or 150b will cause color variation 230 to move quickly along the length of optical fiber 12. At a very high rate of adjustment, however, movement may no longer be perceivable by the human eye.

In FIG. 7, for example, the intensity of light having wavelength 210 emitted by light source 150a is increased. This can be accomplished, for example, by directing potentiometer 410a to increase power to light source 150a, which in turn increases the intensity of the light emitted by light source 150a. In addition to increasing the intensity of the light emitted by light source 150a, the intensity of the light emitted by light source 150b may be simultaneously decreased. Alternatively, the intensity of the light emitted by light source 150b may be decreased. Increasing the intensity of the light emitted by light source 150a, and/or decreasing the intensity of the light emitted by light source 150b, causes color variation 230 at the interplay of the light emitted from the first light source and the light emitted from the second light source to move toward the right, toward light source 150b.

Accordingly, movement of color variation 230 can be directed all along the length of optical fiber 12 by controlling light source 150a and/or 150b. Although color variation 230 at the interplay of the light emitted from the first light source and the light emitted from the second light source is depicted in FIGS. 5-7 as having clearly defined borders, it should be understood that this is for purposes of illustration. Color variation 230 may be, for example, a color created by the mixing of light of first wavelength 210 and second wavelength 220. For example, if first wavelength 210 is a bluish light having wavelength around 475 nm, and second wavelength 220 is a yellowish light having wavelength 575, then color variation 230 may appear to be a one or more of the colors on the CIE color map found along a line drawn between 475 nm and 575 nm. Accordingly, movement along optical fiber 12 may be the movement of this color variation 230 from one end of the fiber to the other end.

As yet another alternative, an aspect of movement of color variation 230 along the length of optical fiber 12 can vary depending on the length of the optical fiber 12, the diffusion length of the light. This aspect can be in addition to, or separate from controlling movement using light sources 150a and 150b. For example, movement can be confined to a certain region of optical fiber 12 by providing the rope with a predetermined distance d, with the first and/or second light sources only able to diffuse to a length less than d. The overlap of the diffusion length of light emitted by light source 150a and the diffusion length of the light emitted by light source 150b will overlap in a central region of optical fiber 12, which is the region to which the movement of color variation 230 will be confined.

Illumination system 400 depicted in FIGS. 4-7 can be adapted to innumerable different configurations. For example, optical fiber 12 can range from a very short fiber to a very long fiber, on the order of meters or more. If optical fiber 12 is bend insensitive, for example, it can be bent, wound, or otherwise adapted to the environment where it will be situated or installed, among many other variations. Accordingly, illumination system 400 has many different applications, only a small number of which can be described herein. According to some embodiments, for example, single or multiple fiber illumination with the light-diffusing fiber(s) 12 can be utilized in aqueous environments, for example for lighting boat docks, fishing lines or lures, and related applications where the small flexible size of the light-diffusing fiber 12 and the ability to be safely immersed in water are highly desirable. The light-diffusing fiber 12 may also be useful for exit lighting, illuminating pathways, emitting IR radiation for room detectors, or used a thread in clothing, particularly protective/reflective clothing to further enhance visibility of the wearer. Examples of the use of the light-diffusing fiber 12 in decorative illumination are manifold, but a few examples are use in appliance lighting and edge effects, automotive/aircraft illumination, or household and furniture illumination. As another example, the illumination system could be used as a sliding dial display in conjunction with a touch sensor (control device), such that as a finger slides along the touch sensor the color variation 230 would move correspondingly with the finger. The illumination system could also be used in conjunction with a device such as an appliance to indicate the status of the cycle. The color variation could move, for example, from an all blue to an all red along the length of a fiber to indicate the status of a washing machine cycle or progress of another predictable or detectable time period. As an example, the illumination systems described herein could be utilized on the surface or around the door of a front load washer indicating the status, and remaining time, for the current wash cycle.

It is to be understood that the foregoing description is exemplary of the invention only and is intended to provide an overview for the understanding of the nature and character of the invention as it is defined by the claims. The accompanying drawings are included to provide a further understanding of the invention and are incorporated and constitute part of this specification. The drawings illustrate various features and embodiments of the invention which, together with their description, serve to explain the principals and operation of the invention. It will become apparent to those skilled in the art that various modifications to the preferred embodiment of the invention as described herein can be made without departing from the spirit or scope of the invention as defined by the appended claims.

What is claimed is:

1. An illumination system comprising:
a light-diffusing optical fiber comprising a first input end and a second input end, the light-diffusing optical fiber having a glass core, a cladding surrounding the glass core, and an outer surface, and further comprising a plurality of nano-sized structures situated within the fiber, the nano-sized structures being configured to scatter light;
a first light source optically coupled to the first input end of the light-diffusing optical fiber and configured to generate light having a first wavelength, wherein an intensity of light emitted from the first light source is adjustable; and
a second light source optically coupled to the second input end of the light-diffusing optical fiber and configured to generate light having a second wavelength, wherein an intensity of light emitted from the second light source is adjustable;
wherein a color variation forms within the light-diffusing optical fiber at a junction of the light emitted from the first light source and the light emitted from the second light source;
wherein the location of the color variation is adjustable along the light-diffusing optical fiber by adjusting intensity of light emitted from one or more of the first light source and the second light source.

2. The illumination system of claim 1, further comprising:
a first potentiometer configured to control a power input to said first light source;
a second potentiometer configured to control a power input to said second light source; and
a microcontroller configured to control at least one of the potentiometers.

3. The illumination system of claim 1, wherein said first light source and said second light source are LEDs.

4. The illumination system of claim 1, wherein the optical fiber comprises a plurality of bends formed therein to preferentially scatter guided light via said nano-sized voids away from the core and through the outer surface.

5. The illumination system of claim 1, wherein said optical fiber has a length L of 0.5 m to 100 m.

6. The illumination system of claim 1 wherein said optical fiber is a multimode fiber, and wherein said core comprises:
a core diameter greater than 50 μm and less than 500 μm; and
a numerical aperture NA>0.2.

7. The illumination system of claim 1 wherein the core of said light-diffusing optical fiber comprises silica and said nano-sized voids are situated in the core.

8. The illumination system of claim 7, wherein said nano-sized voids are situated in the core and said core has an outer diameter Rc, and said core comprises:
a solid inner core section with radius R1, such that 0.1Rc<R1<0.9Rc;
a nano-structured region having a width W2 wherein 0.05Rc<W2<0.9Rc; and
an outer solid core region having a width Ws between 0.1Rc<Ws<0.9Rc;
wherein each section of said core comprises silica glass.

9. The illumination system of claim 1, wherein said core comprises silica doped with at least one of the following dopants: Ge, F.

10. The illumination system of claim 1, wherein the entire core comprises nano-sized voids.

11. The illumination system of claim 1, wherein said cladding comprises either silica based glass or polymer.

12. The illumination system of claim 1, further comprising a coating disposed on the outer surface of the optical fiber, wherein fluorescent species are disposed in the optical fiber coating.

13. The illumination system of claim 1, when said light source generates light in 200-2000 nm wavelength range.

14. The illumination system of claim 1, wherein the optical fiber comprises at least one of pigment, phosphors, fluorescent material, UV absorbing material, hydrophilic material, light modifying material, or a combination thereof.

15. The illumination system of claim 1, wherein the first light source is configured to generate light having two or more wavelengths.

16. The illumination system of claim 1, wherein the second light source is configured to generate light having two or more wavelengths.

17. An automobile comprising an illumination system of claim 1.

18. An illumination system comprising:
a light-diffusing optical fiber comprising a first input end and a second input end, the light-diffusing optical fiber having a glass core, a cladding surrounding the glass core, and an outer surface, and further comprising a plurality of nano-sized structures situated within the glass core or at a core-cladding boundary, the nano-sized structures being configured to scatter light;
a first light source optically coupled to the first input end of the light-diffusing optical fiber and configured to generate light having a first wavelength, wherein the intensity of light emitted from the first light source is adjustable;
a second light source optically coupled to the second input end of the light-diffusing optical fiber and configured to generate light having a second wavelength, wherein the first wavelength, wherein the intensity of light emitted from the second light source is adjustable;
a first potentiometer configured to control a power input to said first light source; and
a second potentiometer configured to control a power input to said second light source;
wherein a color variation forms within the light-diffusing optical fiber at a junction of the light emitted from the first light source and the light emitted from the second light source;
wherein the location of the color variation is adjustable along the light-diffusing optical fiber by adjusting intensity of light emitted from one or more of the first light source and the second light source utilizing one or more of the first and second potentiometers.

19. The illumination system of claim 18, wherein said first light source and said second light source are LEDs.

20. The illumination system of claim 18, further comprising a microcontroller configured to control at least one of the first and second potentiometers.

21. An illumination system comprising:
a light-diffusing optical fiber comprising a first input end and a second input end;
a first light source optically coupled to the first input end of the light-diffusing optical fiber and configured to generate light having a first wavelength, wherein the intensity of light emitted from the first light source is adjustable;
a second light source optically coupled to the second input end of the light-diffusing optical fiber and configured to generate light having a second wavelength, wherein the first wavelength, wherein the intensity of light emitted from the second light source is adjustable;
wherein a color variation forms within the light-diffusing optical fiber at a junction of the light emitted from the first light source and the light emitted from the second light source;
wherein the location of the color variation is adjustable along the light-diffusing optical fiber by adjusting intensity of light emitted from one or more of the first light source and the second light source.

22. The illumination system of claim 21, wherein said optical fiber comprises a scattering mechanism.

23. The illumination system of claim 22, wherein said scattering mechanism comprises a plurality of structural flaws in a waveguide.

24. The illumination system of claim 22, wherein said scattering mechanism comprises a plurality of air lines in said optical fiber.

25. The illumination system of claim 21, further comprising:
a first potentiometer configured to control a power input to said first light source; and
a second potentiometer configured to control a power input to said second light source.
